(19) United States
(12) Patent Application Publication
(10) Pub. No.: US 2014/0063855 A1
(43) Pub. Date: Mar. 6, 2014

(54) BACKPLATE, BACKLIGHT MODULE AND DISPLAY DEVICE

(71) Applicants: Hefei BOE Display Light Co., Ltd., Hefei (CN); BOE Technology Group Co., Ltd., Beijing (CN)

(72) Inventor: Yang YANG, Beijing (CN)

(73) Assignees: Hefei BOE Display Light Co., Ltd., Hefei (CN); BOE Technology Group Co., Ltd., Beijing (CN)

(21) Appl. No.: 14/016,512

(22) Filed: Sep. 3, 2013

(30) Foreign Application Priority Data
Sep. 4, 2012 (CN) 201210323846.X

(51) Int. Cl. F21V 29/00; F21V 8/00

(52) U.S. Cl. CPC F21V 29/004; G02B 6/0085
USPC 362/632; 362/373; 362/97.1

(57) ABSTRACT

The embodiments of the invention provided a backplate, a backlight module and a display device. The backplate comprises a bottom plate; an outer surface of the backplate is coated with a heat dissipation paint. The backlight module comprises the afore-mentioned backplate and a light source directly disposed on the backplate. The display device comprises the afore-mentioned backlight module. The backplate dissipates heat from the light source without a heat dissipation unit, thereby reducing the cost.

### FIELD OF THE ART

Embodiments of the invention relates to a backplate, a backlight module having the backplate, and a display device having the backlight module.

### BACKGROUND

A backlight module is an important component of a display device and provides backlight for the display. However, a light source in the backlight module produces heat while emitting light. In the case that the heat is not effectively dissipated, accumulated heat might damage the light source or other components of the backlight module. The backlight modules in conventional display devices generally employ heat dissipation devices to sink heat. As an example, an edge-lit type backlight module as illustrated in FIG. 1 comprises a backplate 1, an aluminum-based heat dissipation device 2 and a light source 3, the aluminum-based heat dissipation device 2 is disposed on the backplate 1, and the light source 3 is attached to the aluminum-based heat dissipation device 2 via a thermally conductive adhesive. However, the cost of dissipating heat using the heat dissipation device is high.

### SUMMARY

Embodiments of the invention provide a backplate, a backlight module having the backplate, and a display device having the backlight module, which dissipates heat from a light source without a heat dissipation device, thereby reducing the cost.

To solve the above technical problems, the embodiments of the invention provide the following technical solutions.

A backplate for a backlight module, where an outer surface of the backplate is coated with a heat dissipation paint.

Furthermore, the heat dissipation paint is a ceramic paint.

As an example, the ceramic paint is a boron nitride ceramic paint, an aluminum nitride ceramic paint or an aluminum oxide ceramic paint.

An embodiment of the invention further provides a backlight module comprising the afore-defined backplate and a light source disposed directly on the backplate.

The backplate further comprises a bottom plate and a side plate extending upwards from at least one side of the bottom plate; the light source is disposed directly on an inner side of the side plate.

The side plate is bended outwardly such that heat dissipation area is increased.

The heat dissipation paint is applied to at least a region close to the light source.

According to an embodiment of the invention, the outer surface of the backplate is configured as having a saw-teeth structure such that heat dissipation area is increased.

According to an embodiment of the invention, a heat absorbing material is applied to the inner side of the backplate and a heat absorbing material is added to the backplate, where heat generated at the light source is absorbed by the heat absorbing material rapidly and conducted to the heat dissipation material applied to the outer surface of the backplate and then diffused to the air.

The backlight module further comprises:

a light guide plate disposed on the bottom plate of the backplate; and

a supporter disposed on the bottom plate for supporting the light guide plate.

An embodiment of the invention further provides a display device comprising the above-defined backlight module.

With the backplate, the backlight module and the display device provided by the embodiments of the invention, the heat dissipation paint applied to the surface of the backplate helps to dissipate heat from the light source via the backplate directly, thereby saving the usage of the heat dissipation device and reducing the cost for manufacturing the backlight module.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a cross section of a conventional backlight module;

FIG. 2 schematically illustrates a cross section of a backlight module in accordance with an embodiment of the invention;

FIG. 3 schematically illustrates a cross section of a backlight module in accordance with another embodiment of the invention;

FIG. 4 schematically illustrates a cross section of a backlight module in accordance with a further embodiment of the invention; and

FIG. 5 schematically illustrates a cross section of a backlight module in accordance with still another embodiment of the invention.

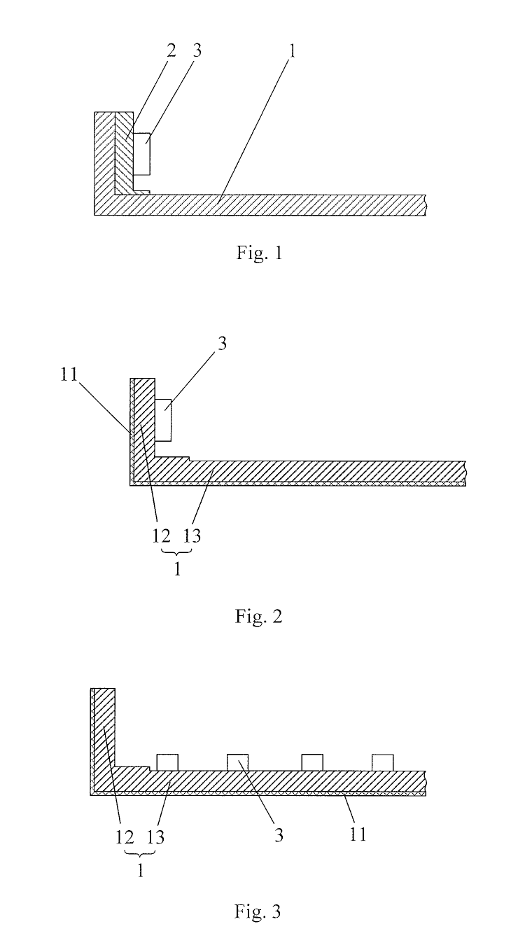

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

As illustrated in FIG. 2, an embodiment of the invention provides a backplate 1 for a backlight module, the backplate 1 comprises a bottom plate 13, an outer surface of the backplate 1 is coated with a heat dissipation paint 11. As an example, a light source 3 may be directly attached to an inner surface of the backplate 1 via a thermally conductive adhesive. The heat dissipation paint 11 coated on the outer surface of the backplate 1 is used for improving heat dissipation efficiency of the surface of the backplate.

Heat dissipation is to rapidly carry heat from a heat source away, such that heat flux in the heat source is decreased and the heat is diffused in the air via convection and radiation. The heat dissipation paint coated on the outer surface of the backplate may transfer heat at the light source quickly to other locations in the backplate, which may facilitate the diffusion of the heat since the backplate itself has a large area. To achieve better effect of heat dissipation, fins are usually provided to an aluminum-based heat dissipation device such that heat dissipation area is increased. However, in the embodiment, the heat dissipation paint is applied to the surface of the backplate to dissipate heat while the molded aluminum-based heat dissipation device is no longer used, thereby reducing material cost as well as fabrication cost. Meanwhile, such a configuration of the backplate may simplify the assembly process for the backlight module and save the space occupied by the backlight module.

Furthermore, the heat dissipation paint 11 is a ceramic paint.

Ceramic paints conduct heat on a basis of phonon heat conduction mechanism and have a high heat conductivity. The mechanism of radiation by the ceramic paints is generating radiation via polarized vibrating non-resonant dual-phonon and multi-phonon, and the radiation efficiency is high. As an example, a boron nitride ceramic paint, an aluminum nitride ceramic paint or an aluminum oxide ceramic paint may be used as the ceramic paint as boron nitride (BN), aluminum nitride (AlN) and aluminum oxide (Al₂O₃) has relatively high heat conductivity and radiation efficiency.

According to the backplate of one embodiment of the invention, the heat dissipation paint is applied to the surface of the backplate, which helps dissipation of the heat from the light source via the backplate directly, thereby saving the usage of the heat dissipation device, reducing the cost and simplifying the assembly process for the backlight module.

Furthermore, as illustrated in FIG. 2, an embodiment of the invention further provides a backlight module which comprises a light source 3 and the above backplate 1, the light source 3 is directly disposed on the backplate 1. The structure of the backplate 1 is the same as the one in the above embodiment and will not be elaborated here.

Moreover, the backplate 1 further comprises a side plate 12 extending upwards from at least one side of the bottom plate 13 and the light source 3 is directly attached to the side plate 12.

Please note that FIG. 2 schematically illustrates a configuration of disposing the light source on the backplate, and is not intended to limit the type of the back light source. For example, as illustrated in FIG. 2, the back light source may be an edge-lit type back light source directly attached to the inner side of the side plate 12. As another example, referring to FIG. 3, the back light source may be a direct-lit type back light source disposed on the bottom plate 13. The light source may also be a line light source such as a light bar, or a dot light source such as a LED, or light sources of other types.

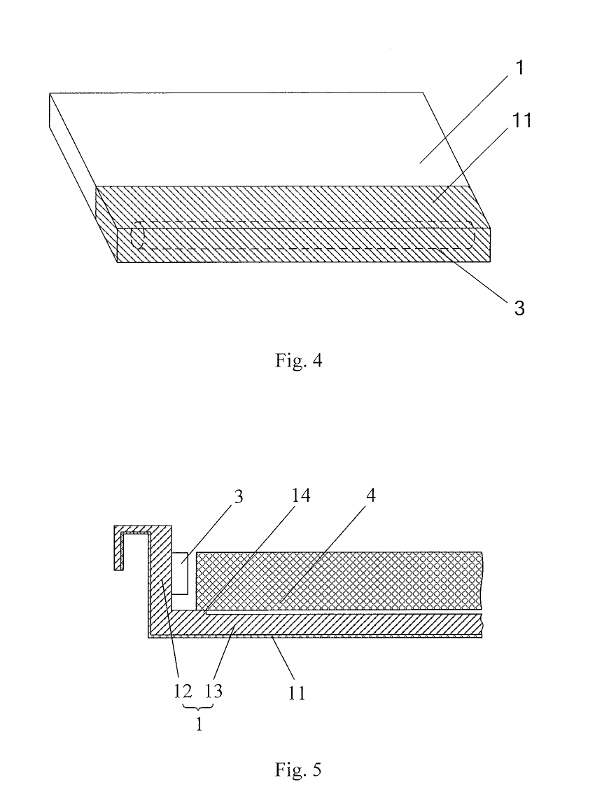

Moreover, as illustrated in FIG. 4, the heat dissipation paint 11 is applied at least to a region close to the light source 3. The location and area needing the application of the heat dissipation paint may be determined according to the location of the light source and actual heat dissipation requirement, and the heat dissipation paint may be applied locally on the premise of ensuring junction temperature of the light source lower than the maximum junction temperature and not damaging the light source, which may reduce the cost while ensuring the heat dissipation effect.

Moreover, as illustrated in FIG. 5, the side plate 12 may be bended outwards relative to the bottom plate 13 such that the heat dissipation area is increased. More specifically, for the edge-lit type backlight source, the light source 3 is directly attached to the inner surface of the side plate 12 via a thermally conductive adhesive. The surface area of the side plate 12 is relatively small which is not advantageous for heat dissipation. Bending the side plate 12 outwardly increases lateral heat dissipation area, thereby improving the heat dissipation effect.

Moreover, the backlight module further comprises a light guide plate (LGP) 4 disposed on the inner side of the backplate 1 and a supporter 14 disposed on the bottom plate 13 for supporting the LGP 4. A conventional heat dissipation device may also support the LGP. In the case of employing the backplate coated with the heat dissipation paint to dissipate heat directly instead of the heat dissipation device, the supporter for supporting the LGP may be disposed on the inner side of the backplate.

According to the backlight module of embodiment of the invention, the heat dissipation paint is applied to the surface of the backplate, which may dissipate the heat from the light source via the backplate directly, thereby saving the usage of the heat dissipation device, reducing the cost and simplifying the assembly process for the backlight module.

Another embodiment of the invention further provides a display device comprising the above backlight module. The configuration of the backlight module is the same as the one in the above embodiment and will not be elaborated here.

According to the display device of embodiment of the invention, the heat dissipation paint is applied to the surface of the backplate, which may dissipate the heat from the light source via the backplate directly, thereby saving the usage of the heat dissipation device, reducing the cost and simplifying the assembly process for the backlight module.

The foregoing are merely exemplary embodiments of the invention, but are not used to limit the protection scope of the invention. The protection scope of the invention shall be defined by the attached claims.

What is claimed is:

1. A backplate for a backlight module comprising a bottom plate, wherein an outer surface of the backplate is coated with a heat dissipation paint.

2. The backplate of claim 1, wherein the backplate further comprises a side plate extending upwards from at least one side of the bottom plate and an outer surface of the side plate is coated with a heat dissipation paint.

3. The backplate of claim 1, wherein the heat dissipation paint is a ceramic paint.

4. The backplate of claim 3, wherein the ceramic paint is a boron nitride ceramic paint, an aluminum nitride ceramic paint or an aluminum oxide ceramic paint.

5. A backlight module comprising a backplate and a light source disposed on the backplate, wherein the backplate is the backplate of claim 1.

6. The backlight module of claim 5, wherein the light source is disposed on the backplate via a thermally conductive adhesive.

7. The backlight module of claim 5, wherein the backplate further comprises a side plate extending upwards from at least one side of the bottom plate and the light source is directly disposed on an inner side of the side plate.

8. The backlight module of claim 7, wherein the light source is disposed on the side plate via a thermally conductive adhesive.

9. The backlight module of claim 7, wherein the side plate is bended outwardly such that heat dissipation area is increased.

10. The backlight module of claim 5, wherein the heat dissipation paint is applied to at least a region close to the light source.

11. The backlight module of claim 10, further comprising:
a light guide plate disposed on an inner side of the backplate; and
a supporter disposed on the bottom plate for supporting the light guide plate.

12. A display device comprising the backlight module of claim 5.
